(19) United States
(12) Patent Application Publication
(10) Pub. No.: US 2011/0000613 A1
(43) Pub. Date: Jan. 6, 2011

(54) Heat Seal Die With Compressible Heat Seal Members and Methods of Use Thereof

(75) Inventors: Edward J. Cigallio, Douglasville, GA (US); Ken Rogers, Roseville, MN (US); Michael Dee Moody, Mansfield, TX (US)

Correspondence Address: SUTHERLAND ASBILL & BRENNAN LLP, 999 PEACHTREE STREET, N.E., ATLANTA, GA, 30309, US

(73) Assignee: PRINTPACK ILLINOIS, INC., Elgin, IL (US)

(21) Appl. No.: 12/827,847

(22) Filed: Jun. 30, 2010

Related U.S. Application Data
(60) Provisional application No. 61/222,392, filed on Jul. 1, 2009.

(51) Int. Cl. B29C 65/02; B30B 5/02

(52) U.S. Cl. 156/290; 156/583.3

(57) ABSTRACT

The present application provides improved heat seal dies and methods of use thereof. The heat seal die includes a first heat seal jaw having a first heat sealing surface and a second heat seal jaw having a second heat sealing surface. The second heat seal jaw may have a plurality of channels and a plurality of resilient compressible members with each resilient compressible member being disposed within one of the channels. The plurality of resilient compressible members may form at least a portion of a second heat sealing surface.

### CROSS-REFERENCES TO RELATED APPLICATIONS

This application claims priority under 35 U.S.C. §119(e) to U.S. Provisional Patent Application Ser. No. 61/222,392, filed on Jul. 1, 2009, which is incorporated herein by reference in its entirety.

### FIELD OF THE INVENTION

The present application relates to heat sealing die for heat sealing flexible packages and more particularly relates to a heat seal die comprising compressible heat seal members.

### BACKGROUND

It is common to package items such as food and drugs in individual serving packages for dispensing to consumers. One common package design is illustrated in FIG. 1. As illustrated in FIG. 1, the package 1 is heat sealed on at least two ends 2, 3 with a heat sealing die. When packaging sauces, it is common for hard, granular objects in the sauce (e.g., crushed peppercorns and the like) to become lodged in heat sealed regions during the heat sealing process. These hard objects can prevent the heat sealing jaws from pressing and sealing the two sides of the package together in the region around the object. In many cases, this leaves a passageway through which the sauce can leak out of the package. Since many individual and bulk serving packages are often packaged together for distribution, even one improperly sealed package can ruin many other packages.

What is desired, therefore, is a heat sealing die capable of reliably forming hermetic heat seals on flexible packages. It is also desirable for the heat sealing die to be capable of utilization in an in-line form, fill and seal packaging process.

### SUMMARY OF THE INVENTION

In one aspect, the present application provides a heat sealing die. In one exemplary embodiment, the heat seal die includes a first heat seal jaw having a first heat sealing surface and a second heat seal jaw having a second heat sealing surface. The second heat seal jaw comprising at least one channel and at least one resilient compressible member contained within the at least one channel. The at least one resilient compressible member forms at least a portion of a second heat sealing surface. The heat seal die is configured to form a heat seal on a package where the package is compressed between the first heat sealing surface and the second heat sealing surface.

In another aspect, the present application provides a heat sealing die that includes a first heat seal jaw having a plurality of ridges. The plurality of ridged form at least a portion of a first heat seal surface. The heat sealing die further includes a second heat seal jaw having a plurality of channels. Each of the plurality of channels is configured to receive one of the plurality of ridges of the first heat seal jaw when the heat seal die compresses the first heat seal jaw and second heat seal jaw together. The heat sealing die further includes a plurality of resilient compressible members removably attached to the second heat seal jaw. Each of the resilient compressible members are contained within one of the plurality of channels of the second heat seal jaw. Each of the plurality of the resilient compressible members are configured to resiliently deform when compressed by one of the ridges of the first heat seal jaw. The plurality of resilient compressible members form at least a portion of a second heat seal surface when disposed within the channels of the second heat seal jaw.

In another aspect, the present application provides a method of heat sealing a package having a first layer and a second layer of a heat sealable material. The method includes providing a heat seal die that includes a first heat seal jaw having a first heat sealing surface; and a second heat seal jaw comprising a channel and a resilient compressible member. The resilient compressible member is contained within the channel, and the resilient compressible member forms at least a portion of a second heat sealing surface. The method further includes feeding the first layer and the second layer of the heat sealable material between the first heat seal jaw and the second heat seal jaw; and compressing the first heat seal jaw and the second heat seal jaw together about the first layer and the second layer of the heat sealable material, thereby deforming the plurality of resilient compressible members and forming a heat seal between the first layer and the second layer of the heat sealable material.

These and other features of the present application will become apparent to one of ordinary skill in the art upon review of the following detailed description when taken in conjunction with the appended claims.

### BRIEF DESCRIPTION OF THE DRAWINGS

FIG. 1 shows a package having at least two heat seals formed by a heat sealing die.

FIG. 2 shows a section view of a heat sealing die according to one or more embodiments of the present invention in the open position.

FIG. 3 shows a section view of a heat sealing die according to one or more embodiments of the present invention in the closed position.

FIG. 4 shows a section view of a heat sealing die according to one or more embodiments of the present invention in the open position to allow packaging film to pass between the jaws of the heat sealing die.

FIG. 5 shows a section view of a heat sealing die according to one or more embodiments of the present invention in the closed position to heat seal the packaging material between the jaws of the heat sealing die.

FIG. 6 shows a section view of heat sealing die according to one or more embodiments of the present invention in the closed position with the resilient compressible members removed.

FIG. 7 is a section view of a heat sealing die according to one or more embodiments of the present invention in the closed position.

FIG. 8 is a section view of a heat sealing die according to one or more embodiments of the present invention in the closed position with the resilient compressible members removed.

FIG. 9 is a section view of a heat sealing die according to one or more embodiments of the present invention in the closed position.

FIG. 10 is a section view of a heat sealing die according to one or more embodiments of the present invention in the closed position with the resilient compressible members removed.

FIG. 11 is a section view of a heat sealing die according to one or more embodiments of the present invention in the open position.

FIG. 12 is a section view of a heat sealing die according to one or more embodiments of the present invention in the closed position.

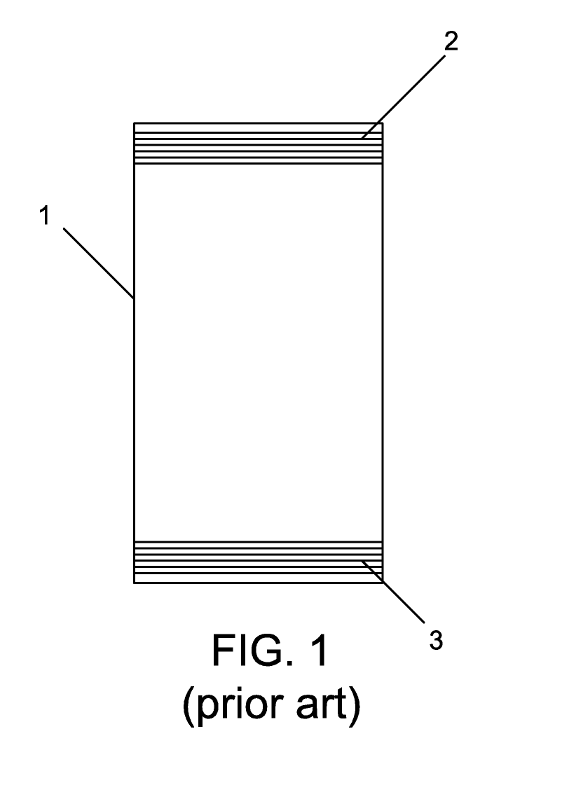

### DETAILED DESCRIPTION

Reference now will be made in detail to various aspects of this invention, including the presently preferred embodiments. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment can be used on another embodiment to yield a still further embodiment. Thus, it is intended that the present invention cover such modifications and variations within the scope of the appended claims and their equivalents.

Heat sealing dies have been developed according to aspects of this invention for reliably forming a heat seal on sauce and other packages. Unlike conventional heat seal dies, which are susceptible to produce a compromised seal when a hard, granular object is presented into the heat seal region, the instant heat seal dies include compressible die members which may allow the heat seal die to form a hermetic seal around objects captured in the heat seal region of the package.

In some embodiments, the compressible resilient members may be removable from the heat seal die and the heat seal die may be capable of forming heat seals with or without the compressible resilient members being present in the die. Such a feature allows the heat seal dies to operate in two different heat sealing modes. In one mode, a heat seal may be formed in a heat-seal forming interface between a ridge of a first jaw and a compressible member situated within a second jaw. In a second mode, a heat seal may be formed in a second heat-seal form interface between a planar surface of the first jaw and a second planar surface of the second jaw.

The heat seal jaw may efficiently transfer heat through the surfaces of the channels of the die into the compressible members to allow for increased machine speeds Also, the use of the compressible members may allow for the die to heat seal a flexible package more gently, reducing the stress placed on the packaging material. Accordingly, in some embodiments, the heat seal die may be utilized in an in-line form, fill and seal packaging process. Furthermore, in some embodiments, the heat seal die may be employed with packaging materials that comprise a foil barrier layer. Advantageously, the resilient members may allow the die to form a heat seal without fracturing the foil barrier layer.

The heat seal dies and methods described herein may be useful for packaging essentially any product. Advantageously, the heat seal dies and methods are particularly useful for heat sealing packages containing a sauce. As used herein, the term “sauce” refers to a food product which is substantially liquid with solid particles contained therein. The heat seal dies and methods, in some embodiments, are also useful for heat sealing packages containing medications, such as drugs. The die may also be used to with flexible packages and containers containing various chemicals, for example, packages containing oils, cleaning fluids, ethylene glycol, or paints. According to a certain embodiment, the heat seal dies and methods are useful in packaging products in flexible portion control packages, such as in a multi-lane form, fill, and seal packaging system.

As used herein, the terms “comprise,” “comprising,” “include,” and “including” are intended to be open, non-limiting terms, unless the contrary is expressly indicated.

### The Heat Seal Die

The present application provides improved heat seal dies and methods for making sealed packages. According to a particular embodiment, the present application provides a heat sealed die with compressible die members.

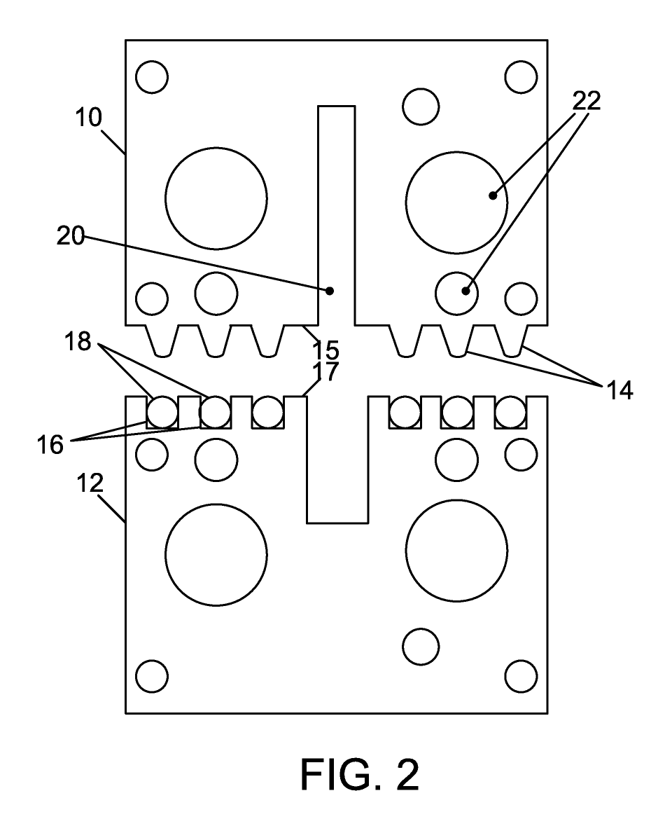

Referring now to the drawings, in which like numerals indicate like elements throughout separate views, FIG. 2 shows one embodiment of a heat seal die having a first heat seal jaw 10 and a second heat seal jaw 12. The first heat seal jaw 10 and second heat seal jaw 12 may comprise a thermally-conductive material such as steel. The desired material of the heat seal jaws 10, 12 may vary depending on the operation temperatures of the die, the compressive force exerted by the die, and other environmental considerations. Furthermore, the heat seal jaws 10, 12 may comprise coatings to improve release of the package material from the heat seal jaws 10, 12 during heat sealing operations.

The first heat seal jaw 10 and second heat seal jaw 12 may also comprise conduits 22 which extend longitudinally through the jaws. The conduits 22 are connected to a source of heat. For example, an electric heating element may be inserted into conduits 22. Alternatively, the conduits 22 may be fluidly connected to a source of a heat transfer fluid such as a steam source. The steam or other heat transfer fluid may circulate through the conduits 22 and heat the first heat seal jaw 10 and the second heat seal jaw 12 to a temperature suitable for heat sealing polymer films. In certain embodiments, the heat seal jaws 10, 12 are both heated.

The first heat seal jaw 10 may have a first heat seal surface 15 which is formed, in part, by a series of ridges 14 which extend longitudinally across the first heat seal surface 15. The second heat seal jaw 12 may have a second heat seal surface 17 which is formed, in part, by a series of discrete resilient compressible members 18 which extend longitudinally across the second heat seal surface 17. As used herein, the term “heat seal surface” or “heat sealing surface,” when used in reference to a surface of a jaw of a heat seal die refers to surface of the die that provides heat and/or pressure to a package material where the die contacts the package material and produces a heat seal in the package material.

In some embodiments, the resilient compressible members 18 are retained within channels 16 such as shown. The compressible members 18 may be retained in this position by friction. Alternatively, the compressible members 18 may be attached within channels 16 by an adhesive or other fastener. The channels 16 and resilient compressible members 18 are configured and positioned to receive and mate with the ridges 14 of the first heat seal jaw 10 when the first heat seal jaw 10 and second heat seal jaw 12 are clamped together.

A cutting slot 20 may be provided in the heat seal jaws 10, 12 for receiving a cutting blade. The cutting blade may pass through the cutting slot 20 and cut the packaging material during or immediately after the heat seals are formed. The cutting blade may be controlled by the same or different actuator that controls the movement of the jaws 10, 12 of the heat seal die.

The resilient compressible members 18 may comprise a resiliently compressible material suitable for use at the operation temperature of the heat seal die. Although the resilient compressible members 18 may be made from various compressible materials, silicone rubber and high-temperature polyurethane are exemplary materials for the resilient compressible members 18. In particular, the resilient compressible members 18 may be formed as an extruded silicone rubber “rope” having a uniform diameter in the longitudinal direction. The rope may then be cut into individual members of the desired length and the individual members may be placed in the channels 16 as shown. Accordingly, the resilient compressible members 18 may be substantially cylindrical in shape.

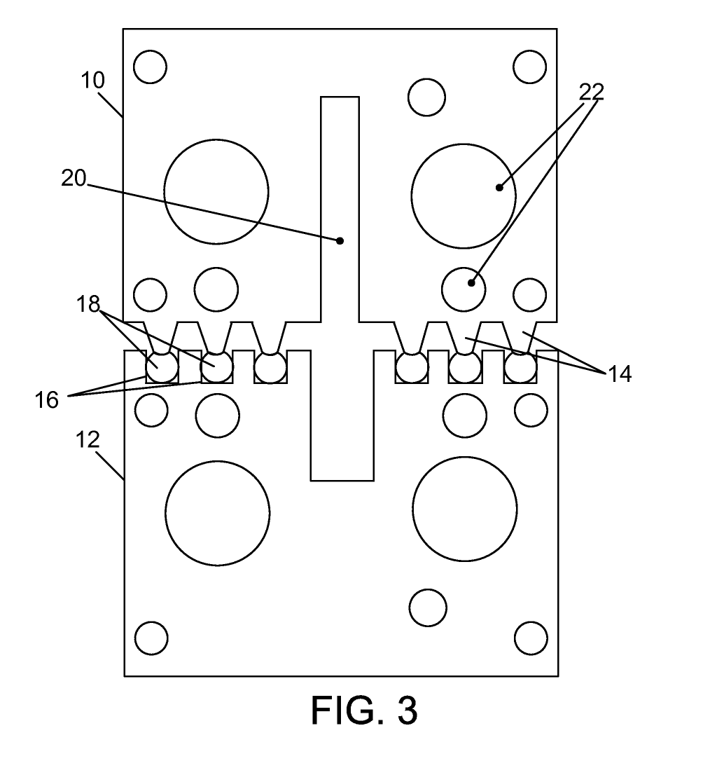

As illustrated in FIG. 3, each of the plurality of ridges 14 may be configured to extend into one of the plurality of channels 16 of the second heat seal jaw 12 and thereby compress the resilient compressible member 18 associated with the channel 16 when the first heat sealing jaw 10 and second heat sealing jaw 12 are compressed together. Furthermore, the resilient compressible members 18 compress when the first heat seal jaw 10 and the second heat seal jaw are clamped together. In doing so, the resilient compressible members 18 conform closely to the surface of the ridges 14 as the ridges 14 are received within the channels 16. The distance the ridges 14 travel into the channels 16 depends upon the magnitude of the clamping force applied to the heat sealing jaws 10, 12 and the compressibility of the resilient compressible members 18. When the heat sealing jaws 10, 12 are returned to their open position, the resilient compressible members 18 return to their original un-deformed shape such as is shown in FIG. 2.

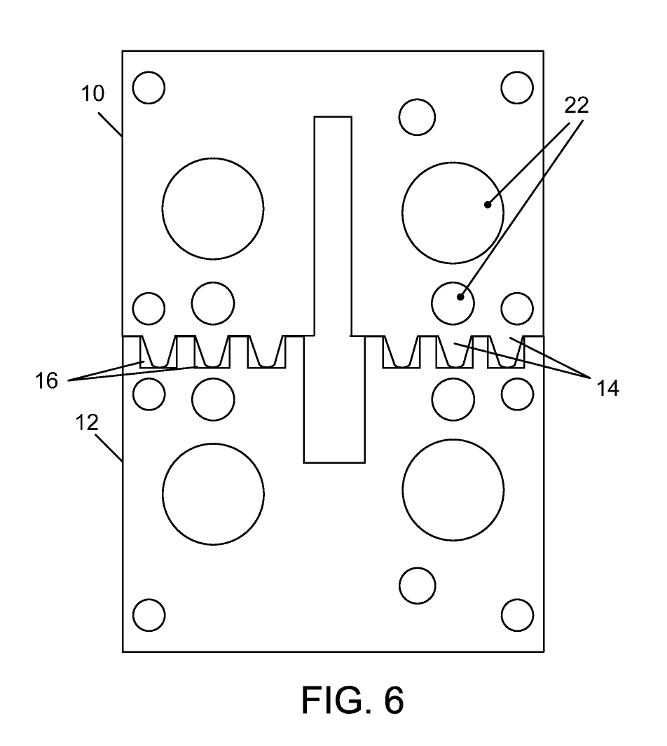

In some embodiments, the resilient compressible members 18 are removable from the channels 16 so as to allow an optional high-pressure heat sealing functionality. As illustrated in FIG. 6, the channels 16 may be dimensioned and configured to receive the ridges 14 in their entirety when the resilient compressible members 18 are removed and the heat sealing jaws 10, 12 are clamped together. This feature allows for higher seal pressures to be applied to the polymer film, when needed, without requiring substitution of heat seal dies. Accordingly, the heat seal die may be operable for forming heat seals with or without the resilient compressible members 18 being present.

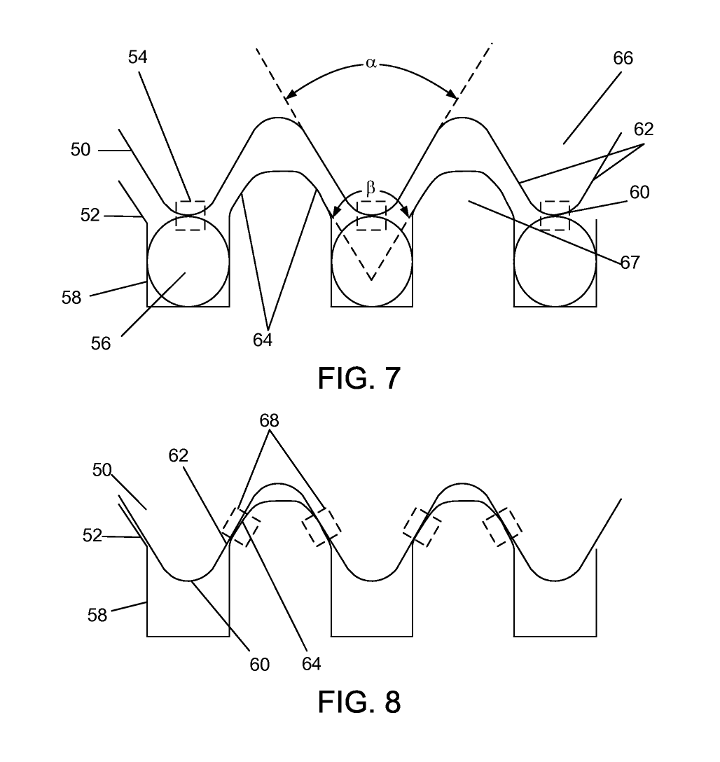

In some embodiments, the heat seal die may be configured such that a first surface of the ridge is used to form a heat seal when a compressible member is in the channel and a second surface of the ridge is sued to form a heat seal when the compressible member removed. As illustrated in FIGS. 7 and 8, a first heat seal jaw 50 may have a plurality of ridges 66. At least one of the ridges 66 includes an apex 60 and a pair of planar surfaces 62. The planar surfaces 62 of the ridge 66 may define an angle α therebetween. The second heat seal jaw 52 may comprise a plurality of channels 58. At least one of the channels 58 may contain a compressible resilient member 56 therewithin. The second heat seal jaw 52 may also include one or more ridges 67 situated adjacent to the channels 58. For example, at least one channel 58 may have two ridges 67 on either side of the channel 58. Each ridge 67 may have a planar surface 64. The planar surfaces 64 of adjacent ridges 67 may define an angle β therebetween. Angle α and angle β may be the same or approximately the same. For example, angle α and angle β may both be between about 45 degrees and about 90 degrees, or about 60 degrees.

In a first heat sealing mode, as illustrated in FIG. 7, heat-sealing interfaces 54 are formed between the apexes 60 of the ridges 66 and the compressible members 56. In a second heat sealing mode, as illustrated in FIG. 8, heat-sealing interfaces 68 are formed between the planar surfaces 62 of the first jaw 50 and the planar surfaces 64 of the second jaw 52 when the apex 60 of the first jaw 50 extends into the channel 58 of the second jaw 52.

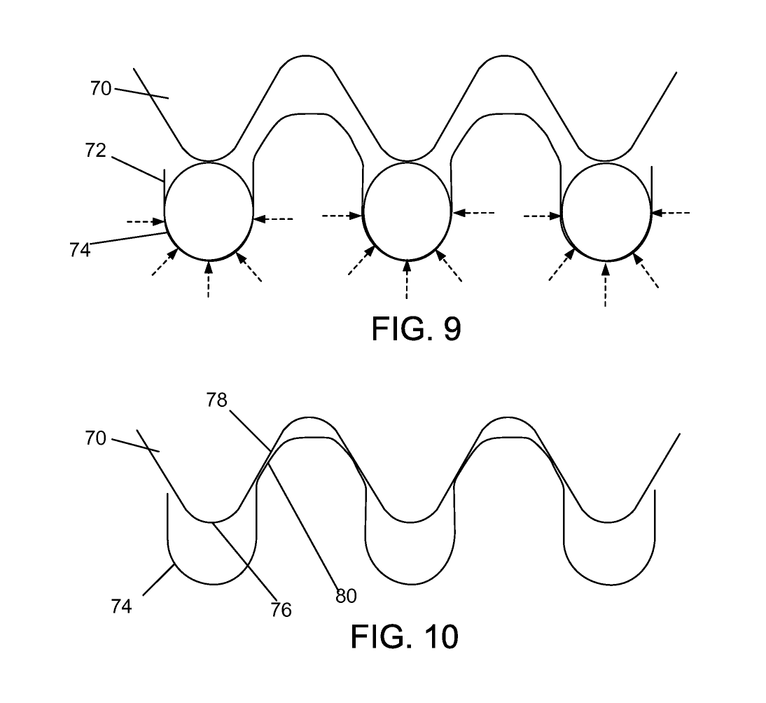

It should be appreciated that in the foregoing embodiments, the compressible resilient members may be heated through the walls of the channels, and heat may be transferred into the compressible members. As such, heat may be transferred into the compressible members from about 180 degrees around the compressible members. In some embodiments, heat transfer may be further enhanced by utilizing a channel shape that conforms with the compressible members. For example, as illustrated in FIGS. 9 and 10, the heat seal die may include a first jaw 70 and a second jaw 72, that has one or more channels 74 for containing one more compressible members. The channels 74 may have substantially cylindrical sidewalls which closely conform to the cylindrically-shaped compressible members. The compressible members may be removed from the channels 74 to enable operation in a second heat-sealing mode. As illustrated in FIG. 10, the apexes 76 of the first jaw 70 may extend into the channels 74 of the second jaw 72 such that heat seals are formed between planar surfaces 78 of the first jaw 70 and planar surfaces 80 of the second jaw 72.

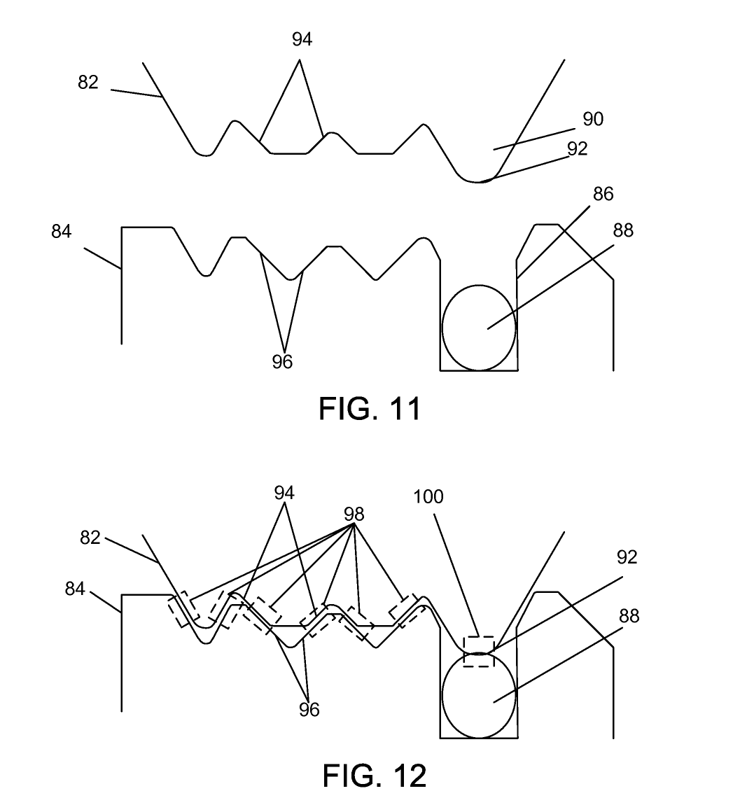

In some embodiments, the heat sealing die forms a two-part heat seal in which a first part of the heat seal is formed with a compressible interface and a second part of the heat seal is formed with a non-compressible interface. For example, a part of a heat seal adjacent to the product contained within a package may be formed with a compressible interface and a port of the heat seal distal to the product may be formed with a non-compressible interface. For example, as illustrated in FIGS. 11 and 12, a first heat seal jaw 82 includes a ridge 90 proximal one side of the heat seal jaw 82 and a plurality of planar surfaces 92 distal from the side of the heat seal jaw 82. The second heat seal jaw 84 includes a plurality of planar surfaces 96 configured to form a non-compressible heat-seal forming interface 98 with the planar surfaces 94 of the heat seal jaw 82 when the heat seal jaws 82 and 84 are moved to a closed position. The heat seal jaw 84 further includes a channel 86 which contains a compressible member 88. The channel 86 is aligned with the ridge 90 of the first jaw 82 such that a compressible heat-seal forming interface 100 is formed between the apex 92 of the ridge 90 and the compressible member 88.

The heat seal die may further include other components that are not specifically illustrated or described herein. For example, the heat seal die may include actuators for moving the jaws of the heat seal die between open and closed positions, sensors for detecting or measuring the compressive force supplied to or exerted through the jaws, heating and/or cooling elements for controlling the temperature of the different surfaces of the jaws, and feed rollers or other feeding devices for aligning or controlling the feed rate of the package material between the jaws of the heat seal die. Because these and other mechanisms are known by those skilled in the art, further discussion of such components is not provided herein.

### Making the Sealed Package

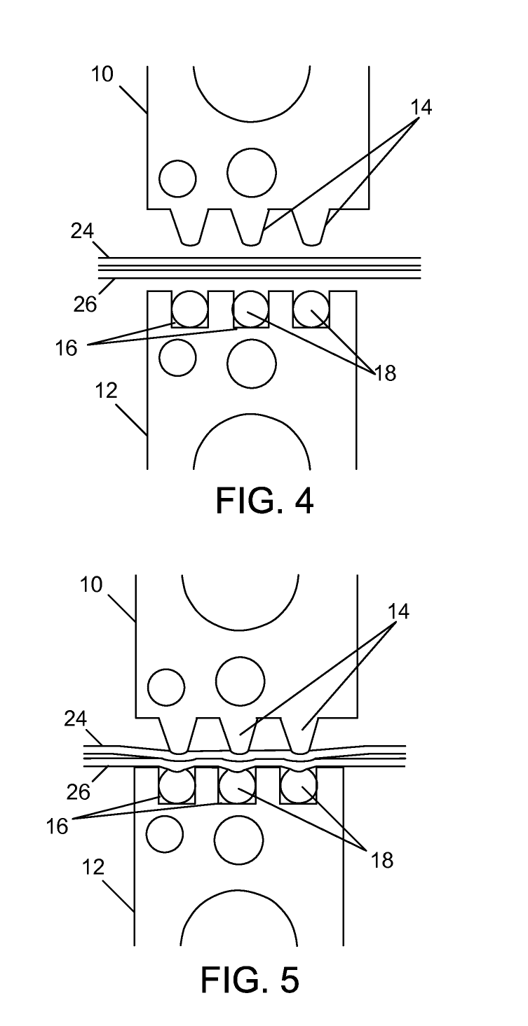

In another aspect, the present application provides methods of making a sealed package using an improved heat seal die. As illustrated in FIG. 4, two layers of heat-sealable polymer film 24, 26 may be fed through the heat seal die between the first heat seal jaw 10 and the second heat seal jaw 12. Although only two discrete layers of polymer film are shown, in some embodiments, the layers 24 and 26 may each comprise two or more layers of film which are laminated together. In either case, the surface of the film layer 26 facing the film layer 24 may be heat-sealable to the surface of film layer 24 facing the film layer 26. As such, when the layers are compressed together and heat is applied, as illustrated in FIG. 5, the layers 24, 26 are heat sealed together at locations where heat and pressure are applied to the layers 24, 26.

Once the layers 24, 26 are heat sealed together, adjacent packages optionally may be cut apart by passing a blade through the cutting slot 20 to sever adjacent packages between the trailing edge seal of the leading package and the leading edge seal of the trailing package. The heat seal jaws 10, 12 may then be returned to the position of FIG. 4, and a feeder may index the layers 24, 26 forward a pre-designated distance. The heat seal jaws 10, 12 may then be actuated, once again, to clamp together to form a new set of heat seals. The duration of the movement of the heat sealing jaws from the closed position after a seal is formed, to the open position while the feeder indexes the packing material, and back to the closed position until the heat seal is formed constitutes a single “cycle.”

Advantageously, it has been found that the use of compressible members 16 in the shown configuration allows for hermetic seals to be reliably formed in packaging films with fewer instances of leakage. This is particularly useful when packaging sauces, especially when using a multi-lane form, fill, and seal system for packaging sauces in flexible portion control packages. With conventional heat sealing dies, solid particles trapped within the heat seal region of the package may prevent the heat sealing surfaces of the heat seal jaws from applying adequate pressure to the layers 24, 26 to produce a hermetic heat seal. The resilient compressible members 18, however, compress and conform around any hard particles trapped in the heat seal region and allow a heat seal to be formed around the particle.

As mentioned previously, each of layers 24 and 26 may comprise one or more layers of film. The surface of the layers 24, 26 facing the contents of the package may comprise a heat sealable material. Accordingly, various polymeric material may be used for the layers 24, 26 including, but not limited to, polyolefins, polyamides and other thermoplastic polymers. In addition, the layers 24 and 26 may comprise additional film layers laminated to the heat-sealable layer which provide improved barrier properties to the package such as polyethylene terephthalate (“PET”) and/or metalized films. In some embodiments, one or more of the layers 24 and 26 may comprise a foil layer for improved barrier performance.

In some embodiments, the first heat sealing surface of the first heat seal jaw 10 comprises a plurality of ridges 14. Each of the plurality of ridges 14 may be configured to extend into one of the plurality of channels 16 and thereby compress the resilient compressible member 18 associated with the channel 16 when the first heat sealing jaw 10 and second heat sealing jaw 12 are compressed together. In some embodiments, the method further includes the step of maintaining the first heat seal jaw 10 and the second heat seal jaw 12 in a compressed state thereby forming the heat seal.

In some embodiments, the heat seal die may be employed as part of an in-line form, fill and seal packaging process. Advantageously, the heat seal die with resilient compressible members 18 is capable of reliably forming hermetic heat seals at a rate suitable for use in such an in-line process.

It should be understood that the foregoing relates only to the preferred embodiments of the present application and that numerous changes and modifications may be made herein without departing from the general spirit and scope of the invention as defined by the following claims and the equivalents thereof

We claim:

1. A heat seal die comprising:
a first heat seal jaw having a first heat sealing surface; and
a second heat seal jaw comprising at least one channel and at least one resilient compressible member contained within the at least one channel, the at least one resilient compressible member forming at least a portion of a second heat sealing surface;
wherein the heat seal die is configured to form a heat seal on a package where the package is compressed between the first heat sealing surface and the second heat sealing surface.

2. The heat seal die of claim 1, wherein the heat seal die comprises a plurality of resilient compressible members.

3. The heat seal die of claim 1, wherein the first heat sealing surface of the first heat seal jaw comprises a plurality of ridges.

4. The heat seal die of claim 3, wherein one of the plurality of ridges is configured to extend into the at least one channel and thereby compress the at least one resilient compressible member when the first heat sealing jaw and second heat sealing jaw are compressed together.

5. The heat seal die of claim 1, wherein the at least one resilient compressible members comprise silicone rubber or high-temperature polyurethane.

6. The heat seal die of claim 1, wherein the at least one resilient compressible member is substantially cylindrical having a substantially uniform diameter in a longitudinal direction.

7. The heat seal die of claim 1, wherein the at least one resilient compressible member is removable from the second heat seal jaw, and wherein the heat seal die is operable for forming a heat seal without the at least one resilient compressible member being present within the heat seal die.

8. The heat seal die of claim 1, wherein the heat seal die is configured to form a two-part heat seal, wherein a first part of the heat seal is formed within a compressible heat-seal forming interface and a second part is formed within a non-compressible heat-seal forming interface.

9. A heat seal die comprising:
a first heat seal jaw having a plurality of ridges, the plurality of ridged forming at least a portion of a first heat seal surface;
a second heat seal jaw having a plurality of channels, each of the plurality of channels configured to receive one of the plurality of ridges of the first heat seal jaw when the heat seal die compresses the first heat seal jaw and second heat seal jaw together; and
a plurality of resilient compressible members removably attached to the second heat seal jaw, each within one of the plurality of channels of the second heat seal jaw; each of the plurality of the resilient compressible members configured to resiliently deform when compressed by one of the ridges of the first heat seal jaw; the plurality of resilient compressible members forming at least a portion of a second heat seal surface when disposed within the channels of the second heat seal jaw.

10. The heat seal die of claim 9, wherein the plurality of resilient compressible members comprise silicone rubber.

11. The heat seal die of claim 9, wherein each of the plurality of resilient compressible members is substantially cylindrical having a substantially uniform diameter in a longitudinal direction.

12. The heat seal die of claim 9, wherein the plurality of resilient compressible members are removable from the second heat seal jaw, and wherein the heat seal die is operable for forming a heat seal without the plurality of resilient compressible members being present within the heat seal die.

13. A method of heat sealing a package having a first layer and a second layer of a heat sealable material comprising:
providing a heat seal die comprising:
a first heat seal jaw having a first heat sealing surface; and
a second heat seal jaw comprising a channel and a resilient compressible member, the resilient compressible member contained within the channel; the resilient compressible member forming at least a portion of a second heat sealing surface;
feeding the first layer and the second layer of the heat sealable material between the first heat seal jaw and the second heat seal jaw; and
compressing the first heat seal jaw and the second heat seal jaw together about the first layer and the second layer of the heat sealable material, thereby deforming the plurality of resilient compressible members and forming a heat seal between the first layer and the second layer of the heat sealable material.

14. The method of claim 13, wherein the first heat sealing surface of the first heat seal jaw comprises a plurality of ridges.

15. The method of claim 14, wherein the second heat seal jaw comprises a plurality of resilient compressible members and a plurality of channels, each of the plurality of resilient compressible members disposed within one of the plurality of channels, and wherein each of the plurality of ridges configured to extend into one of the plurality of channels and thereby compress the resilient compressible member associated with the channel when the first heat sealing jaw and second heat sealing jaw are compressed together.

16. The method of claim 13, wherein the resilient compressible member comprise silicone rubber or high-temperature polyurethane.

17. The method of claim 13, wherein the resilient compressible member is substantially cylindrical having a substantially uniform diameter in a longitudinal direction.

18. The method of claim 13, wherein the package further comprises a foil layer.

19. The method of claim 13, wherein the resilient compressible member is removable from the second heat seal jaw, and wherein the heat seal die is operable for forming a heat seal without the compressible member being present within the heat seal die.

20. The method of claim 13, wherein the heat seal die is configured to form a two-part heat seal, wherein a first part of the heat seal is formed within a compressible heat-seal forming interface and a second part is formed within a non-compressible heat-seal forming interface.
